(19) United States
(12) Patent Application Publication
(10) Pub. No.: US 2009/0071603 A1
(43) Pub. Date: Mar. 19, 2009

(54) Method of manufacturing printed circuit board and electromagnetic bandgap structure

(75) Inventors: Ja-Bu Koo, Suwon-si (KR); Mi-Ja Han, Suwon-si (KR); Han Kim, Yongin-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 12/007,474

(22) Filed: Jan. 10, 2008

(30) Foreign Application Priority Data
Sep. 14, 2007 (KR) 10-2007-0093546

(51) Int. Cl. B32B 38/14

(52) U.S. Cl. 156/277

(57) ABSTRACT

A method of manufacturing a 4-layered printed circuit board by one-time stacking process is disclosed. In particular, the printed circuit board manufacturing method includes adhering copper clad laminates (CCL) to both surfaces of a foam tape; forming an inner layer circuit pattern on one of both copper thin layers of the CCL, the one copper thin layer being not adhered to the foam tape; separating the CCL from the foam tape; arranging the copper thin layer in which the inner layer circuit pattern is formed to face a prepreg; compressing the CCL into the prepreg; and forming an outer layer circuit pattern on one of both copper thin layers of the CCL, the one copper thin layer being in no contact with the prepreg.

### CROSS-REFERENCE TO RELATED PATENT APPLICATIONS

This application claims the benefit of Korean Patent Application No. 10-2007-0093546, filed on Sep. 14, 2007, in the Korean Intellectual Property Office, the disclosure of which is incorporated herein in its entirety by reference.

### BACKGROUND OF THE INVENTION

1. Field of the Invention

The present invention relates to a printed circuit board manufacturing method.

2. Background Art

Various apparatuses such as mobile communication terminals, personal digital assistants (PDA), laptop computers and digital multimedia broadcasting (DMB) devices have been launched in order to meet today's trend that mobility is considered as one of the most important issues.

Such apparatuses include a printed circuit board, which is configured to compound analog circuits (e.g. radio frequency (RF) circuits) and digital circuits for wireless communication.

The printed circuit board has a multi-layer structure. In the case of including a layer having a dielectric material of a high dielectric constant, the adhesiveness may be lowered according to the increased amount of filler due to lacking flexibility as compared with the typical insulation layer. This results in the lamination.

Accordingly, it is required to increase an adhesion to prevent the delamination. This needs the surface planarization, the method for which is described with reference to FIG. 1A through 1F.

FIG. 1A through FIG. 1F are sectional views showing a printed circuit board according to a manufacturing method for surface planarization.

In the manufacture of a metal carrier for circuit formation, carrier coppers 11a and 11b are adhered to upper and lower surfaces of a foam tape 10. Then, seed layers 12a and 12b are formed through nickel plating for the circuit formation (refer to FIG. 1A).

After that, a dry film 13 is applied to the seed layers 12a and 12b and an empty space is formed for mask, exposure development and etching processes. Circuit patterns 14a and 14b are formed by filling the empty space through electroplating (refer to FIG. 1B).

After completing the plating, the remaining dry film 13 is removed. The carrier coppers 11a and 11b are separated from the foam tape 10 (refer to FIG. 1C).

The circuit patterns 14a and 14b is adequately placed in an insulation material 15, and then, the seed layers 12a and 12b consisting of nickel is etched (refer to FIG. 1D). A via 16 is formed by performing a laser for interconnection of each layer.

For via fill plating, the via 16 is removed by using a dry film 17 through mask, exposure, development and etching processes after electroless copper plating. The via 16 is charged by performing the via fill plating (refer to FIG. 1E).

After that, the dry film is delaminated, and then, a desired circuit is realized by using a soft etching (refer to FIG. 1F).

The aforementioned printed circuit board manufacturing method forms two-layered structure. Then, it is necessary to perform a typical stacking process of the printed circuit board. Accordingly, using a metal carrier can allow the surface planarization to be acquired. However, it is required to perform a lot of processes that needs much cost and time.

### SUMMARY OF THE INVENTION

The present invention provides a printed circuit board manufacturing method that can reduce time and cost by decreasing nickel plating and stacking processes.

An aspect of the present invention features a printed circuit board manufacturing method that can form a 4-layer structure by using a one-time stacking process.

According to an embodiment of the present invention, a printed circuit board manufacturing method includes steps of adhering copper clad laminates (CCL) to both surfaces of a foam tape; forming an inner layer circuit pattern on one of both copper thin layers of the CCL, the one copper thin layer being not adhered to the foam tape;

separating the CCL from the foam tape; arranging the CCL to allow the copper thin layer in which the inner layer circuit pattern is formed to face a prepreg, the prepreg being placed between the CCL; compressing the CCL into the prepreg; and forming an outer layer circuit pattern on one of both copper thin layers of the CCL, the one copper thin layer being in no contact with the prepreg. Here, at least one of the CCL can include a dielectric layer, consisting of a material having a high dielectric constant, and the copper thin layers, formed on the both surfaces of the dielectric layer.

The separating step can separate the CCL from the foam tape by supplying heat.

The compressing step can bury the inner layer circuit pattern in the prepreg.

The dielectric layer can consist of a dielectric material having a dielectric constant of 7 through 1000.

The CCL can have thickness of 7 through 25 μm.

An aspect of the present invention features an electrode bandgap structure manufacturing method that blocks a signal having a frequency band.

According to an embodiment of the present invention, an electromagnetic bandgap structure manufacturing method can include steps of adhering a first copper clad laminate (CCL) and a second CCL to both surfaces, respectively, of a foam tape; allowing a metal plate to be formed on one of both copper thin layers of the first CCL, the one copper thin layer being not adhered to the foam tape, and a first metal layer to be formed on one of both copper thin layers of the second CCL, the one copper thin layer being not adhered to the foam tape; separating the first CCL and the second CCL from the foam tape; allowing the first CCL to be arranged to have the copper thin layer formed with the metal plate face a prepreg and the second CCL to be arranged to have the copper thin layer formed with the first metal layer face the prepreg, the prepreg being placed between the first CCL and the second CCL; compressing the first CCL and the second CCL into the prepreg; forming a clearance hole on one of copper thin layers of the first CCL and one of copper thin layers of the second CCL, the one copper thin layer of the first CCL and the one copper thin layer of the second CCL being in no contact with the prepreg; and forming a via, accommodated into the clearance hole. Here, the first CCL can include a dielectric layer, consisting of a material having a high dielectric constant, and the copper thin layers, formed on the both surfaces of the dielectric layer.

The separating step can separate the first CCL and the second CCL from the foam tape by supplying heat.

The compressing step can bury the metal plate and the first metal layer in the prepreg.

The dielectric layer can consist of a dielectric material having a dielectric constant of 7 through 1000.

The first CCL can have thickness of 7 through 25 μm.

### BRIEF DESCRIPTION OF THE DRAWINGS

These and other features, aspects and advantages of the present invention will become better understood with regard to the following description, appended claims and accompanying drawings where:

FIG. 1A through FIG. 1F are sectional views showing a printed circuit board according to a manufacturing method for surface planarization;

FIG. 2A through FIG. 2I are sectional views showing a printed circuit board according to a manufacturing method in accordance with an embodiment of the present invention;

FIG. 3 is a sectional view showing a 4-layer electromagnetic bandgap structure in accordance with an embodiment of the present invention; and

FIG. 4 is a 3-D perspective view showing a 4-layer electromagnetic bandgap structure in accordance with an embodiment of the present invention.

### DESCRIPTION OF THE EMBODIMENTS

Since there can be a variety of permutations and embodiments of the present invention, certain embodiments will be illustrated and described with reference to the accompanying drawings. This, however, is by no means to restrict the present invention to certain embodiments, and shall be construed as including all permutations, equivalents and substitutes covered by the spirit and scope of the present invention. Throughout the drawings, similar elements are given similar reference numerals. Throughout the description of the present invention, when describing a certain technology is determined to evade the point of the present invention, the pertinent detailed description will be omitted.

Terms such as “first” and “second” can be used in describing various elements, but the above elements shall not be restricted to the above terms. The above terms are used only to distinguish one element from the other.

The terms used in the description are intended to describe certain embodiments only, and shall by no means restrict the present invention. Unless clearly used otherwise, expressions in the singular number include a plural meaning. In the present description, an expression such as “comprising” or “consisting of” is intended to designate a characteristic, a number, a step, an operation, an element, a part or combinations thereof, and shall not be construed to preclude any presence or possibility of one or more other characteristics, numbers, steps, operations, elements, parts or combinations thereof.

Hereinafter, some embodiments of the present invention will be described in detail with reference to the accompanying drawings.

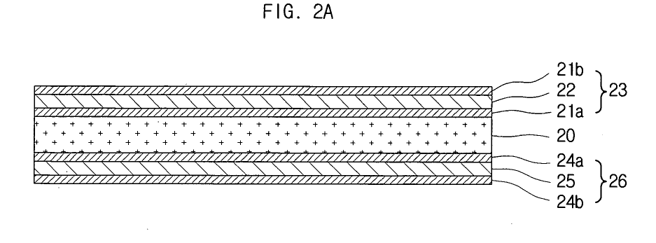

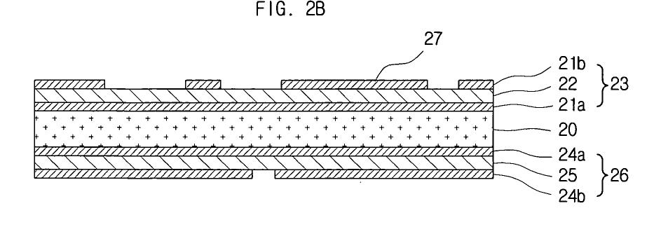

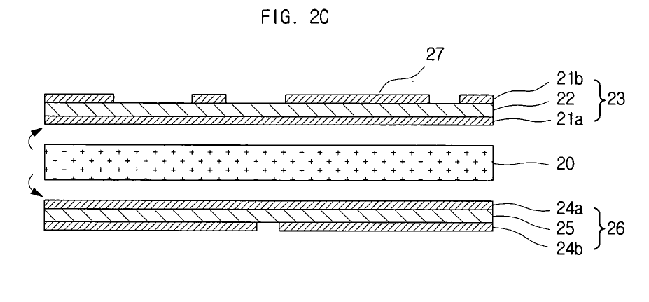

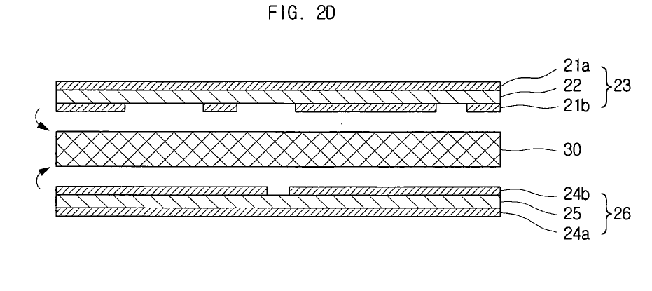

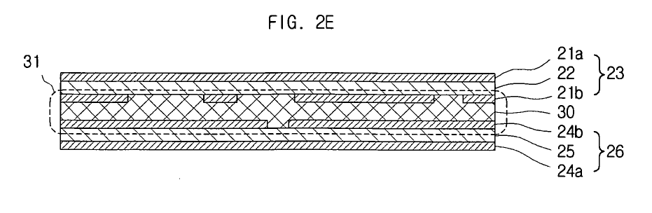

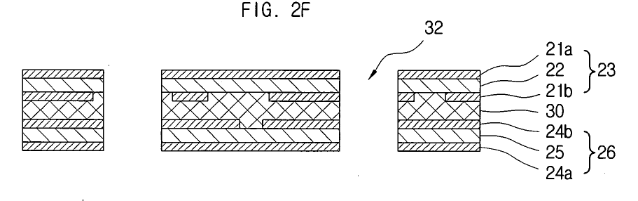

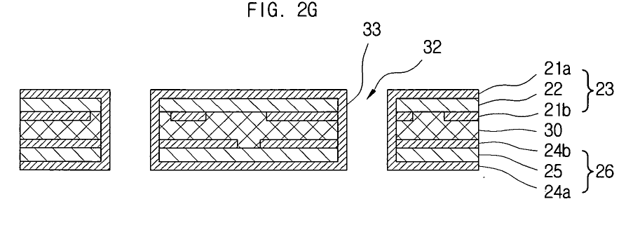

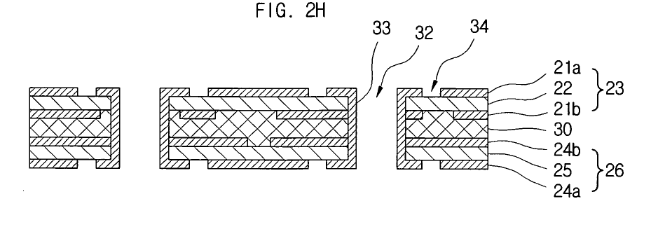

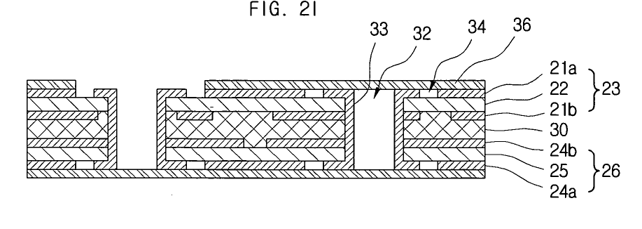

FIG. 2A through FIG. 2I are sectional views showing a printed circuit board according to a manufacturing method in accordance with an embodiment of the present invention

Copper clad laminates (CCL) 23 and 26 can be adhered to both surfaces of a foam tape 20 (refer to FIG. 2A). In the following process, a first CCL 23 is assumed to form a first layer and a second layer of the printed circuit board, and a second CCL 26 is assumed to form a third layer and a fourth layer of the printed circuit board. In this case, in the 4-layer structured printed circuit board, the outer layer circuits, which are the first and fourth layer, can be in contact with the foam tape 20, and the inner circuit layers, which are the second and third layers, can be exposed to an outside.

In particular, the first CCL 23 can include a dielectric layer 22 consisting of a high dielectric constant, and a first copper-clad layer 21a and a second copper-clad layer 21b, formed in both surfaces, respectively, of the dielectric layer 22. The first copper-clad layer 21a can be in contact with the foam tape 20 to form the first layer of the printed circuit board, and the second copper-clad layer 21b forms the second layer.

The second CCL 26 can include a dielectric layer 25 consisting of a high dielectric constant, and a third copper-clad layer 24b and a fourth copper-clad layer 24a, formed in both surfaces, respectively, of the dielectric layer 25. The fourth copper-clad layer 24a can be in contact with the foam tape 20 to form the fourth layer of the printed circuit board, and the third-clad layer 24b forms the third layer.

Each dielectric layer 22 and 25 of the first CCL 23 and the second CCL 26 can have the dielectric constants of 7 through 1000 and the thickness of 7 through 25 μm. As compared with the typical dielectric layer having the dielectric constant of 3 through 5 and the thickness of 30 through 1000 μm. The dielectric layer 22 and 25 can have the very large dielectric constant and small thickness. Also, the dielectric layer 22 and 25 can be stiff due to being consisting of high dielectric constant material, which is beneficial to the surface planarization.

Since it is impossible to use a device for a circuit formation process by one CCL due to the dielectric layers having thin thickness, two CCLs 23 and 26 can be adhered to both surfaces of the foam tape 20, and the foam tape 20 can be placed between the two CCLs 23 and 26. The foam tape 20 is removable through a high-temperature and high-pressure process.

After that, a photo resist such as dry film or LPR can be applied to the copper thin layer 21b of the first CCL 23 and the third copper thin layer 24b of the second CCL 26, and a circuit pattern 27 can be formed through mask, exposure, development, etching and delamination processes (refer to FIG. 2B). In other words, internal-layer circuits corresponding to the second layer and the third layer of the 4-layered printed circuit board can be formed.

After that, the first CCL 23 and the second CCL 26 can be separated from the foam tape 20 by performing the high-temperature and high-pressure process by use of a nickel oven (refer to FIG. 2C).

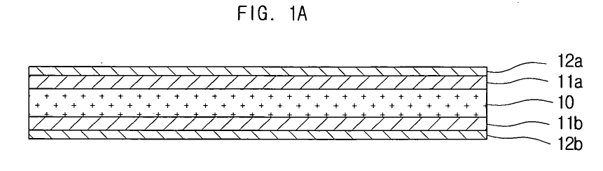

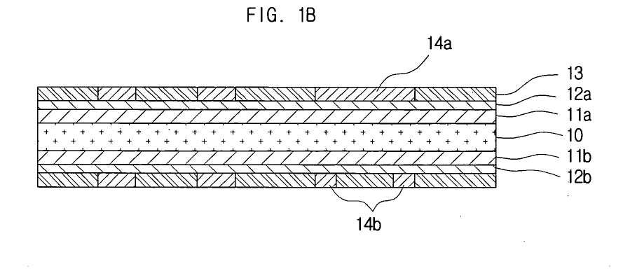

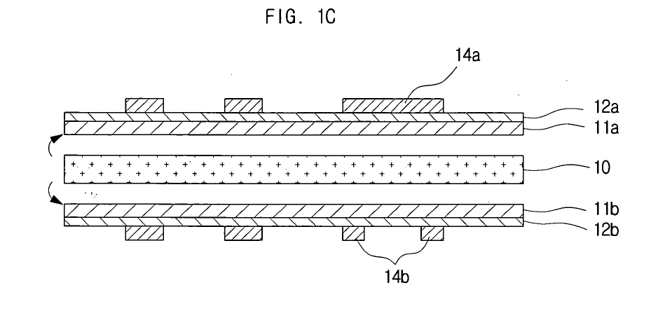

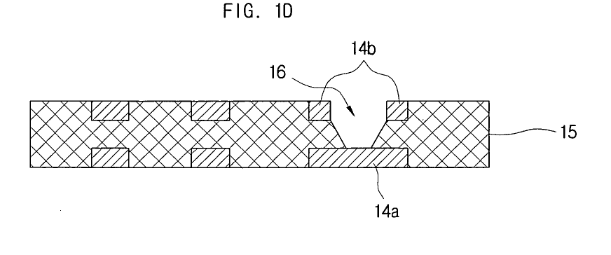

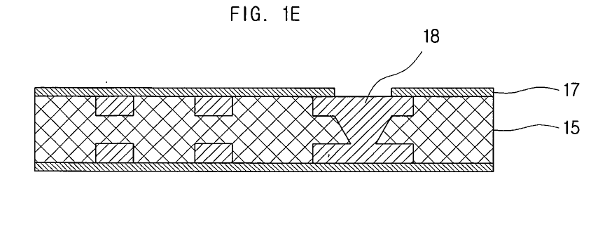

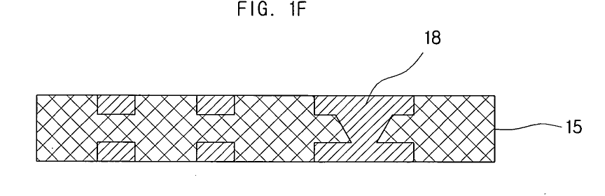

Through the aforementioned processes shown in FIG. 2A through 2B, the present invention can decrease time and cost by reducing a nickel plating process that is necessary in the conventional process shown in FIG. 1A through 1C.

Then, the first CCL 23 and the second CCL 26 can be arranged to allow the second copper thin layer 21b and the third copper thin layer 24b, formed with circuit pattern 27, to face a prepreg 30 placed between the first CCL 23 and the second CCL 26 (refer to FIG. 2D). In other words, the first CCL 23 and the second CCL 26 can be arranged to allow the second copper thin layer 21b and the third copper thin layer 24b to be the inner layer circuits, which is the second layer and third layer, respectively, of the 4-layered printed circuit board.

Here, a surface-treatment for increasing the adhesiveness with the prepreg 30 can be additionally performed on surfaces of the second copper thin layer 21b and the third copper thin layer 24b. The surface-treatment can include the black oxidation that improves the adhesion by the increase of a surface area by oxidizing the surface of the copper thin layer into Cu₂O or CuO and prevents the adhesion of a boundary surface to be lowered.

The first CCL 23 and the second CCL 26 can be adhered to the prepreg 30 by compressing the first copper thin layer 21a and the fourth copper thin layer 24a, respectively, in which the circuit pattern is not formed (refer to FIG. 2E).

Since the circuit pattern has not yet been formed in the first copper thin layer 21a of the first CCL 23 and the fourth copper thin layer 24a of the second CCL 26, high pressure press may not damage the first copper thin layer 21a and the fourth copper thin layer 24a and can make the circuit pattern, which is formed in the second copper thin layer 21b and the third copper thin layer 24b, buried in the prepreg 30. The buried circuit pattern can prevent each layer from being delaminated.

Then, it is possible to form an outer-layer circuit of the 4-layered printed circuit board by using the second copper thin layer 21b of the first CCL 23 and the third copper thin layer 24b of the second CCL 26 without an additional stacking process when the 4-layered printed circuit board is manufactured.

To electrically interconnect each layer of the printed circuit board shown in FIG. 2E, a via 32 can be formed through a drilling process (refer to FIG. 2F) or a via plating 33 can be used through electroless copper plating and electrolytic copper plating (refer to FIG. 2G). At this time, the fill plating filling up the inside of the via 32 can be performed or the internal wall of the via 32 can be plated and then the empty space can be filled with a plugging ink, a conductive paste or a dielectric substance.

Then, a photo resist can be applied to the first copper thin layer 21a of the first CCL 23 and the fourth copper thin layer 24a of the second CCL 26 and then a circuit pattern 34 of outer layers (i.e. the first layer and the fourth layer of the printed circuit board) can be formed through mask, exposure, development, etching and delamination processes (refer to FIG. 2H).

Also, a solder resist 36 can be applied and a part in which a surface-treatment will be performed can be formed through the mask, exposure, development, etching and delamination process. Then, the surface-treatment can be performed to complete making an interposer (refer to FIG. 2I). Here, the surface-treatment refers to forming a film in order to improve abrasion resistance, heat resistance, corrosion resistance, electroconductivity and soldering and to improve ornament such as lustrousness. The surface-treatment can include electroless Ni/Au plating, hot solder air leveling (HSAL), organic solderability preservative (OSP), immersion tin and immersion silver.

Through the aforementioned processes, the 4-layered printed circuit board can be formed. It is possible to add an outer layer to both surfaces of the 4-layered printed circuit board shown in FIG. 2H through the typical stacking process before the soldering process in order to manufacture 6 or 8-layered printed circuit board.

The electronic bandgap structure can have the structure in which a metal plate, placed between a first metal layer and a second metal layer and arranged parallel to each metal layer, is connected to one of the first and second metal layers through a via. Here, one of the first mental layer and the second mental layer can be a power layer, and the other can be a ground layer.

In other words, the electromagnetic bandgap structure can have the bandgap structure formed between the power layer and the ground layer and preventing a signal having a frequency band from penetrating it. The signal having the frequency band can prevented from penetrating it by resistance, inductance, capacitance and conductance, formed between the first metal layer, the second metal layer, the metal layer and the via.

A problem mixed signals may be generated between a digital circuit and an analog circuit (e.g. an RF circuit) because an operation frequency of the digital circuit and an electromagnetic (EM) wave by harmonics components are transferred to the RF circuit 140. The mixed signal problem may be generated due to the EM wave, having a frequency within the frequency band in which the RF circuit is operated, in the digital circuit. This problem may result in obstructing the accurate operation (e.g. transmitting and receiving of the wireless signal) of the RF circuit 140. Accordingly, the signal having the frequency band corresponding to the operation frequency of the analog circuit can be prevented from being transferred from the digital circuit to the analog circuit by arranging the foresaid electromagnetic bandgap structure between the digital circuit and the analog circuit, realized in the same printed circuit board, in order to solve the problem.

Hereinafter, a 4-layer electromagnetic bandgap structure manufactured by using the foregoing printed circuit board will be described with reference to a sectional view and 3-D perspective view.

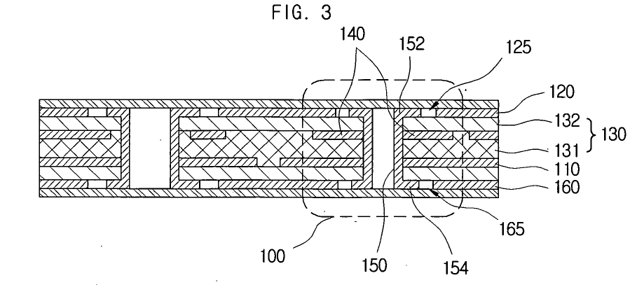

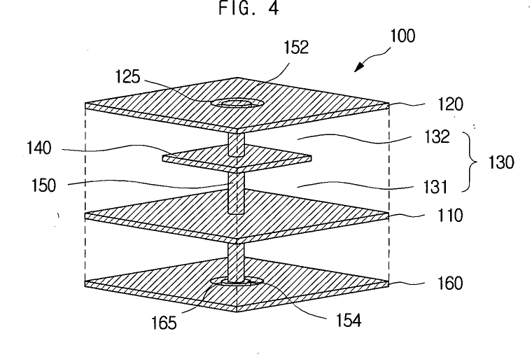

FIG. 3 is a sectional view showing a 4-layer electromagnetic bandgap structure in accordance with an embodiment of the present invention, and FIG. 4 is a 3-D perspective view showing a 4-layer electromagnetic bandgap structure in accordance with an embodiment of the present invention.

The electromagnetic bandgap structure 100 can include a first mental layer 110, a second mental layer 120, a metal plate 140, a dielectric layer 130 and a via 150.

The metal plate 140 can be placed between the first mental layer 110 and the second metal layer 120.

The dielectric layer 130 can be distinguished into a first dielectric layer 131 and a second dielectric layer 132 according to a formation time. The metal plate 140 is placed between the first dielectric layer 131 and the second dielectric layer 132.

The first metal layer 110, the second metal layer 120, the metal plate 140 and the via 150 can consist of a metal material (e.g. copper) capable of transferring a signal by being provided with a power.

The first dielectric layer 131 and the second dielectric layer 132 can consist of the same dielectric materials, materials having the same dielectric component or different dielectric materials. It is required to increase a capacitance value of the electromagnetic band gap structure 100 in order to prevent a low frequency to be transferred. The capacitance value of the electromagnetic band gap structure 100 can be increased by using the second dielectric layer 132, having a thin thickness, placed between the metal plate 140 and the second metal layer 120 or using an insulation material having a high dielectric constant. The adhesiveness of the insulation material having the high dielectric constant may be lowered according to the increased amount of filler due to lacking flexibility as compared with the typical insulation layer. Accordingly, as described above, using a CCL consisting of the dielectric material having the high dielectric constant can make it possible to increase the dielectric constant of the second dielectric layer 132, to thereby lower the prevented frequency as desired in the identically sized electromagnetic bandgap structure.

If the first mental layer 110 is the ground layer, the second metal layer 120 can be the power layer 120. If the first mental layer 110 is the power layer, the second metal layer 120 can be the ground layer. In other words, the first metal layer 110 and the second metal layer 120 can be each one of the first ground layer and the power layer which are close to each other and between which the dielectric layer 130 is placed.

The via 150 can be expanded in both directions to the first metal layer 110 and the second metal layer 120 and be connected to the metal plate 140 placed between the first metal layer 110 and the second metal layer 120. Here, the via 150 can be connected to the first metal layer 110, but disconnected to the second metal layer 120.

The second metal layer 120 can be formed with a clearance hole 125. The clearance hole 125 can have the same center as the via 150 and a larger diameter than the via 150. The clearance hole 125 can refer to the void in the circuit pattern of the second mental layer 120 which is formed to have a larger diameter than the via land 152, connected to the via 150, on the same planar surface as the second metal layer 120. Since the via 150 passes through the inside of the clearance hole 125 formed in the second metal layer 120, the via 150 can be disconnected to the second metal layer 120. A via land 152 can be formed inside the clearance hole 125. The via land 152 can be connected to the via 150.

If the metal plate 140 is the power layer, since the via 150 penetrates through the inside of the clearance hole formed in the ground layer, the via 150 can be disconnected to the ground layer. If the metal plate 140 is the ground layer, since the via 150 penetrates through the inside of the clearance hole formed in the power layer, the via 150 can be disconnected to the power layer.

Alternatively, the via 150 can be connected to the metal plate 140 and the first metal layer 110. Since the via 150 passes through the clearance hole formed in other metal layers, the via 150 can be disconnected to the metal layers.

For example, a third metal layer 160, shown in FIG. 4, can be the metal layer of the printed circuit board placed opposite to the metal plate 140. The first metal layer 110 can be placed between the third metal layer 160 and the metal 140. The third metal layer 160 can be also formed with a clearance hole 165. The clearance hole 165 can have the same center as the via 150 and a larger diameter than the via 150. The clearance hole 165 can refer to the void in the circuit pattern of the third mental layer 160 which is formed to have a larger diameter than the via land 152, connected to the via 150, on the same planar surface as the second metal layer 120. Since the via 150 passes through the inside of the clearance hole 165 formed in the third metal layer 160, the via 150 can be disconnected to the third metal layer 160. A via land 154 can be formed inside the clearance hole 165. The via land 154 can be connected to the via 150.

The via 150 can have the penetration structure in which the via 150 is not formed in some layers but the via 150 passes through all layers and the via 150 is connected to the first metal layer 110 but is disconnected to other metal layers.

The electromagnetic bandgap structure 100 can be formed as illustrated in FIG. 3.

As compared with the printed circuit board shown in FIG. 2I, the first copper thin layer 21b of the first CCL 23, the second copper thin layer 21a, the circuit pattern formed in the second copper thin layer 21a and the dielectric layer 22 can correspond to the metal plate 140, the second metal layer 120, the clearance hole 125 and the second dielectric layer 132, respectively. The third copper thin layer 24b of the second CCL 26, the fourth copper thin layer 24a and the circuit pattern formed in the third copper thin layer 24b can correspond to the first metal layer 110, the third metal layer 160 and the clearance hole 165, respectively. In addition, the prepreg 30 and the via 33 can correspond to the first dielectric layer 131 and the via 150 of the electromagnetic bandgap structure 100, respectively.

In other words, the dielectric layer 22 of the first CCL 23 can correspond to the second dielectric layer 132 of the electromagnetic bandgap structure 100. In the case of consisting of the dielectric material having the high dielectric constant, the frequency to be blocked can be lowered.

Although some embodiments of the present invention have been described, anyone of ordinary skill in the art to which the invention pertains should be able to understand that a very large number of permutations are possible without departing the spirit and scope of the present invention and its equivalents, which shall only be defined by the claims appended below.

1. A printed circuit board manufacturing method, comprising:
adhering copper clad laminates (CCL) to both surfaces of a foam tape;
forming an inner layer circuit pattern on one of both copper thin layers of the CCL, the one copper thin layer being not adhered to the foam tape;
separating the CCL from the foam tape;
arranging the CCL to allow the copper thin layer in which the inner layer circuit pattern is formed to face a prepreg, the prepreg being placed between the CCL;
compressing the CCL into the prepreg; and
forming an outer layer circuit pattern on one of both copper thin layers of the CCL, the one copper thin layer being in no contact with the prepreg,
whereas at least one of the CCL includes a dielectric layer, consisting of a material having a high dielectric constant, and the copper thin layers, formed on the both surfaces of the dielectric layer.

2. The method of claim 1, wherein the separating step separates the CCL from the foam tape by supplying heat.

3. The method of claim 1, wherein the compressing step buries the inner layer circuit pattern in the prepreg.

4. The method of claim 1, wherein the dielectric layer consists of a dielectric material having a dielectric constant of 7 through 1000.

5. The method of claim 1, wherein the CCL has thickness of 7 through 25 μm.

6. A method of manufacturing an electromagnetic bandgap structure, the method comprising:
adhering a first copper clad laminate (CCL) and a second CCL to both surfaces, respectively, of a foam tape;
allowing a metal plate to be formed on one of both copper thin layers of the first CCL, the one copper thin layer being not adhered to the foam tape, and a first metal layer to be formed on one of both copper thin layers of the second CCL, the one copper thin layer being not adhered to the foam tape;
separating the first CCL and the second CCL from the foam tape;
allowing the first CCL to be arranged to have the copper thin layer formed with the metal plate face a prepreg and the second CCL to be arranged to have the copper thin layer formed with the first metal layer face the prepreg, the prepreg being placed between the first CCL and the second CCL;
compressing the first CCL and the second CCL into the prepreg;
forming a clearance hole on one of copper thin layers of the first CCL and one of copper thin layers of the second CCL, the one copper thin layer of the first CCL and the one copper thin layer of the second CCL being in no contact with the prepreg; and
forming a via, accommodated into the clearance hole,
whereas the first CCL includes a dielectric layer, consisting of a material having a high dielectric constant, and the copper thin layers, formed on the both surfaces of the dielectric layer.

7. The method of claim 6, wherein the separating step separates the first CCL and the second CCL from the foam tape by supplying heat.

8. The method of claim 6, wherein the compressing step buries the metal plate and the first metal layer in the prepreg.

9. The method of claim 6, wherein the dielectric layer consists of a dielectric material having a dielectric constant of 7 through 1000.

10. The method of claim 6, wherein the first CCL has thickness of 7 through 25 μm.
